(19) United States
(12) Patent Application Publication
(10) Pub. No.: US 2009/0006229 A1
(43) Pub. Date: Jan. 1, 2009

(54) System and method for telephony billing codes

(75) Inventors: Jeffrey M. Sweeney, Olathe, KS (US); Jennifer D. Doyle, Olathe, KS (US)

Correspondence Address: PATTON BOGGS, LLP, 2001 ROSS AVENUE, SUITE 3000, DALLAS, TX, 75201, US

(73) Assignee: Embarq Holdings Company, LLC

(21) Appl. No.: 11/823,791

(22) Filed: Jun. 28, 2007

(51) Int. Cl. G06Q 30/00; G06Q 10/00; G06Q 50/00

(52) U.S. Cl. 705/34

(57) ABSTRACT

A system and method for implementing a billing service plan for separating communications expenses. Expenses related to a communication for an individual user are separated into two or more categories based on user input before, during, or after the communication occurs. The expenses of the communication are apportioned to the two or more categories based on the user input. An invoice is generated for one or more parties specifying the expenses apportioned to the two or more categories.

### BACKGROUND

The use of and development of communications has grown nearly exponentially in recent years. The growth is fueled by larger networks with more reliable protocols and better communications hardware available to service providers and consumers. Users have similarly grown to expect better communications from home, work and on the go. Many users often use communications devices, such as a cellular telephone, for business as well as personal use. In many cases, users are issued wireless devices or services by their employer.

Frequently, users with employer supplied devices and services are expected to pay for personal use of devices or service. For example, personal calls to family or friends that may incur expenses from a work-issued wireless device need to be fully paid for. Personal usage may include sending or receiving text messages, email, network access, chatting, or other messages and communication usage. Similarly, a user may expense out costs related to doing business from a personal wireless device. As a result, each month the user may be required to separate or invoice expenses for personal use and business use. The process is extremely time consuming because the user may have limited information regarding the time and type of communication. In many cases, the issue may be further complicated if the user cannot remember whether the communication was for a business or personal purpose.

Despite the complexity of separating expenses, it is necessary for companies to accurately report business expenses. Similarly, self-employed or small businesses that may use a single communication service for business and personal use may need to accurately account for business usage for legal and tax purposes. Trying to estimate business expenses for tax purposes can be especially difficult and nerve-racking considering the potential consequences of an incorrectly filed tax statement. Inaccuracies or unreported expenses may expose the user to liability or uncompensated expenses. In other cases, it is difficult to determine what percentage of the base costs or fees should be allocated to personal or business usage of the service or device. The problem is particularly difficult for individuals and small businesses that may not have the resources or ability to apportion expenses. As a result, the time and effort required to properly and accurately reconcile a billing statement for a user with both personal and professional usage may negatively impact the overall customer experience.

### SUMMARY

To provide accounting, tax, and reimbursement options to individuals and small businesses that use communication devices for personal and business purposes, a system and method for implementing a billing service plan for separating communications expenses is provided. In one embodiment, expenses related to a communication for an individual user may be separated into two or more categories based on user input before, during, or after the communication occurs. The expenses of the communication may be apportioned to the two or more categories based on the user input. An invoice may be generated for one or more parties specifying the expenses apportioned to the two or more categories.

Another embodiment includes a billing system for separating communications expenses. The system may include a server configured to separate a communication into two or more categories based on user input, apportion expenses related to the communication to one of the two or more categories, and separate the expenses based on the two or more categories in an invoice to a user. The billing system may also include a communications network in communication with the server, the communications network configured to send and receive the communication for the user.

Yet another embodiment includes a billing system for managing communications expenses. The billing system may include a rules-based engine for executing a set of instructions to categorize the communications expenses. The set of instructions may be configured to categorize a communication into two or more categories based on user input, apportion expenses of the communication based on the two or more categories, and separate the expenses based on the two or more categories In an invoice to a user.

### BRIEF DESCRIPTION OF THE DRAWINGS

Illustrative embodiments of the present invention are described in detail below with reference to the attached drawing figures, which are incorporated by reference herein and wherein:

FIG. 1 is a perspective drawing of a communications system according to an embodiment;

FIG. 2 is a block diagram of a billing system in accordance with an illustrative embodiment;

FIG. 3 shows examples of communications devices in accordance with an embodiment;

FIG. 4 is a flowchart of a process for selecting a category in accordance with an illustrative embodiment;

FIG. 5 is a flowchart of a process for apportioning costs in accordance with an illustrative embodiment;

FIG. 6 is a flowchart of a process for specifying criteria in accordance with an illustrative embodiment;

FIG. 7 is a flowchart of a process for apportioning expenses in accordance with an illustrative embodiment;

FIG. 8 is a flowchart of a process for apportioning costs for wireless calls in accordance with an illustrative embodiment; and

FIG. 9 is a graphical user interface in accordance with an illustrative embodiment.

### DETAILED DESCRIPTION OF THE DRAWINGS

Illustrative embodiments of the present invention provide a system and method for billing codes. Many large businesses may use a private telephone switch (PBX) to perform different forms of communications separation for billing purposes. The same features and billing abilities are not available to individual users, which include individuals and small businesses. An individual user or small business may have difficulties separating telecommunication services into categories which may include business and personal usage. An illustrative embodiment allows a user to specify different categories for characterizing expenses related to telecommunication services. In particular, a user may specify whether a communication is for a personal or business purpose to facilitate expense allocation and tax accounting.

The billing systems and methods herein described may be part of all communications services provided to customers. In another embodiment, the user may be required to sign up for a service plan, package, or feature in order to have the ability to separate expenses for billing purposes. For example, in order to be granted access to a graphical user interface for setting communications separation criteria or manually selecting selection criteria, the user may be required to subscribe to a particular communications service package. In one embodiment, the service plan may establish the instructions, rules, policies, and principles for implementing the methods herein described. The service plan may be implemented by software instructions, hardware, or a combination thereof.

In one embodiment, the expenses may be separated based on pre-specified criteria. As a result, communications that fit a specified category are separated and summed in one category. In another embodiment, the user may specify how to characterize the communication at the time the communication is initiated or received. Telecommunication services may include wireline telephone service including traditional plain old telephone service (POTS), and voice over Internet Protocol (VoIP) telephone service, and wireless service. The categories may be used to separate telecommunications expenses for different users for personal and business provided devices.

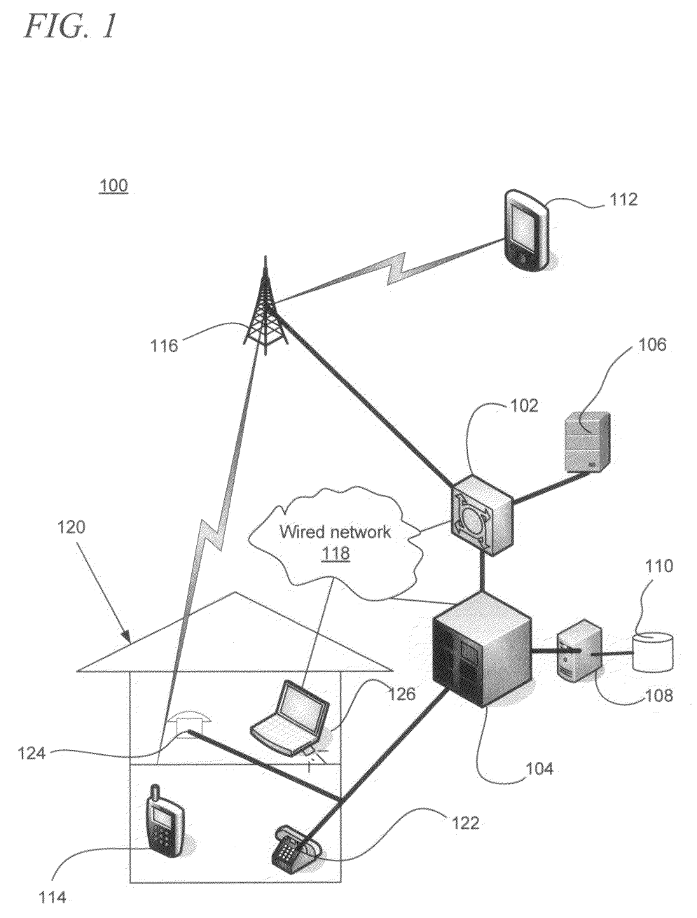

FIG. 1 is a perspective drawing of a communications system in accordance with an illustrative embodiment. The communications system of FIG. 1 includes various elements used for wireless and wired communication. The communications system 100 includes a mobile switching center 102, a local exchange 104, billing systems 106 and 108, database 110, wireless devices 112 and 114, transmission tower 116, wired network 118, a home 120, home telephones 122 and 124, and client 126. In one embodiment, the different elements and components of the communications system 100 communicate using wireless communications including satellite connections or hardwired connections, such as fiber optics, Ti, cable, DSL, high speed trunks, and telephone lines.

The wireless devices 112 and 114 may communicate with the transmission tower 116 using communications protocols, such as time division multiple access (DMA), code division multiple access (CDMA), global systems for mobile (GSM) communications, personal communications systems (PCS), WLAN, WiMAX, or other frequently used cellular and data communications protocols and standards. The wireless devices 112 and 114 may include cellular phones, Blackbery®, personal digital assistances (PDA), laptops, evolution data optimized (EDO) cards, multi-mode devices, and other wireless communication devices and elements. Communications within the communications system 100 may occur on any number of networks which may include wireless networks, data or packet networks, private networks, publicly switched telephone networks (PSTN), and the wired network 118. The networks of the communications system 100 may represent a single communication service provider or multiple communications services providers. The features of the present invention may be implemented by one or more elements of the communications system 100 independently or as a networked implementation.

In one embodiment, the mobile switching center 102, billing system 106, and transmission tower 116 are part of a wireless network that is operated by a wireless service provider. For example, the control signals and operational features may be performed by the mobile switching center 102 and the wireless signals maybe broadcast from the transmission tower 116 to the wireless devices 112 and 114. The wireless network may include any number of systems, towers, servers, and other network and communications devices for implementing the features and performing the methods herein described.

The mobile switching center (ABC) 102 may be a switch used for wireless call control and processing. The MSC 102 may also serve as a point of access to the local exchange 104. The MSC 102 is a telephone exchange that provides circuit switched calling and mobility management and may also provide GSM or personal communications system (PCS) services to the wireless devices 112 and 114 located within the area the MSC 102 serves. The MSC 102 may include a home locator record (HLR) and virtual locator record (VLR) that may be used to implement different features of illustrative embodiments.

The billing system 106 may be an integrated part of the MSC 102 or alternatively may be an externally connected device. In one embodiment, the billing system 106 may include an integrated or network database for storing customer and communication usage information and data. The billing system 106 may store information and preferences for categorzing and sorting communications and communication related expenses into the categories defined by the user. The categorization may be made based on pre-set policies, rules, and criteria or may occur at or subsequent to the time the communications are performed. The mobile switching center 102 and billing system 106 may include any number of hardware and software components. In one embodiment, the MSC 106 is an advanced intelligence network device with software modules equipped to perform billing functions.

The local exchange 104 and MSC 102 communicate using a signal control protocol, such as a signaling system number 7 (SS7) protocol. The SS7 protocol is used in publicly switched networks to establish connections between switches, performing out-of-band signaling in support of the call-establishment, billing, routing, and information-exchange functions of the publicly switched network 104. The local exchange 104 may be owned and operated by a local exchange carrier that provides standard telephone service to any number of users. In one embodiment, the local exchange 104 may be a class 5 switch that is part of the network systems of the local carrier. The local exchange 104 may include or may be connected to the billing system 106. However, the local exchange 104 may also be a Digital Subscriber Line Access Multiplexer PSLAM), Internet Protocol (IP) gateway, base station or any other suitable network access point.

The local exchange 104 may be a wire-line switch or public exchange using time domain multiplexing to provide telecommunications services to a particular subscriber or groups of subscribers. The local exchange 104 maybe located at a local telephone company's central office, or at a business location serving as a private branch exchange. The local exchange 104 may provide dial-tone, calling features and additional digital and data services to subscribers, such as home phones 122 and 124. The local exchange 104 may also enable VoIP communication of the home telephones 116 and 118 through a data network VoIP works by sending voice information in digital form in packets, rather than in the traditional circuit-committed protocols of the publicly switched network

The communications system 100 may further include any number of hardware and software elements that may not be shown in the example of FIG. 1. For example, in order to facilitate VoIP communications, the communications system and the MSC 102 and local exchange 104 in particular may include application servers, media servers, service brokers, call agents, edge routers, gateways (signaling, trunking, access, sub, etc.), IP network service providers, exchanges, switches, users, and networks. The billing system 108 is similar to the billing system 106 except that it is equipped to handle billing for landline customers rather than wireless customers. The local exchange 104 or other components of a wire line network, such as data, PSTN, VoIP, or other wired network may implement the features and perform the methods herein described.

The MSC 102 and local exchange 104 may include an authentication space. The authentication space may be a partition of the server or other storage designated by the communications service provider. The authentication space may validate that a user or device, such as client 126, is allowed to authorize the MSC 102 or local exchange 104 or corresponding billing system 106 and 108 to set preferences, implement changes, review information, or perform other updates. For example, a user may be first required to provide a secure identifier, such as a user name, password, or other authentication code or hardware interface that verifies the user is authorized to make changes within the authentication space. The authentication information may be used to create a secure connection between the client and the MSC 102 and local exchange 104. The secure connection may be a virtual private network tunnel, an encrypted connection, firewall, or other form of secured communications link The MSC 102 and local exchange 104 may use any number of gateways, proxies, applications, or interfaces for allowing the client 126 to the MSC 102 and local exchange 104 through the wired network 118. Alternatively, the client 126 may use a wireless network or other network to access the MSC 102 and local exchange 104. The MAC 102 and local exchange 104 may use a host client application for communicating with numerous clients.

The home 120 is an example of a dwelling or residence of a person or group that may use any number of communications services. The home 120 is shown as a residence in the illustrated example, however, the home 120 may also be an office, business, or other structure wired or otherwise suitably equipped to provide telephone, data, and other communication services to one or more customers. In one embodiment, the home 114 is equipped with multiple communication devices, including home telephones 122 and 124 and client 126. The home telephones 122 and 124 may be standard devices that provide dial tone and dialing, and voice conversation capabilities. Home telephone 122 may be integrated in any number of other devices or may be used in different forms. For example, the home telephone 122 may be part of a refrigerator. In another embodiment, the home telephone 124 may be integrated with a personal computer, such as client 126.

Client 126 may be a personal computer for performing and executing programs and instructions and accessing the wired network 118. However, the client 126 may be any computing devices suitable for communicating with the wired network 118. The wired network 118 may be a fiber optic, cable, or telephone network or other wired network suitable for communication over a hard wired connection with the client 126. In one embodiment, the home 120 may include a wireless router that allows the client 126 to communicate with the wired network 118. The MNC 102 and local exchange 104 may use a graphical user interface (GUI), such as website or program accessible from the client 126 in order to receive user input for the billing systems 106 and 108.

In one embodiment, the user may be required to sign up for a service package or billing feature in order to be granted access to the billing system 106 and 108 for the separation and accounting of billing expenses. For example, the GUI maybe used to review normal billing invoices and calls unless the user has subscribed to a specialized billing separation service plan. If the user has subscribed to the specialized communications plan or feature, the GUI may be enabled to allow the user to provide user input for separation of communications before, during, or after they occur.

The communication services accessible from the home telephones 122 and 124 may include standard telephone service or VoIP telephone service. The home telephones 122 and 124 may be VoIP telephones or may be standard telephones that include a modem and/or VoIP adapters for enabling VoIP communications.

In an illustrative embodiment, the user may select a category for billing purposes using devices, such as wireless devices 112 and 114, home telephones 122 and 124, and client 126. Calls and other messages and data communications maybe made and received from the home telephones 122 and 124, wireless devices 112 and 114, and client 126. At any time, a user may select to enable, order, initiate, configure, reconfigure or otherwise establish the billing method herein described. The user may enable billing to a specified category in a number of ways.

For example, the user may use a command that informs the MSC 102 or local exchange 104 or billing systems 106 and 108 how to categorize the communications for billing. The command may be a signal generated to activate a function trigger for a device, such as the MAC 102, local exchange 104, billing systems 105 and 106, wireless device 112 and 114, home telephones 122 and 124, or client 126. In one example, the user may submit a command to categorize the communications to a business category by dialing *2 on the home telephone 12. The command may also be a password, voice activated, time activated, preset by user selection or any other suitable option, setting, command, or user input.

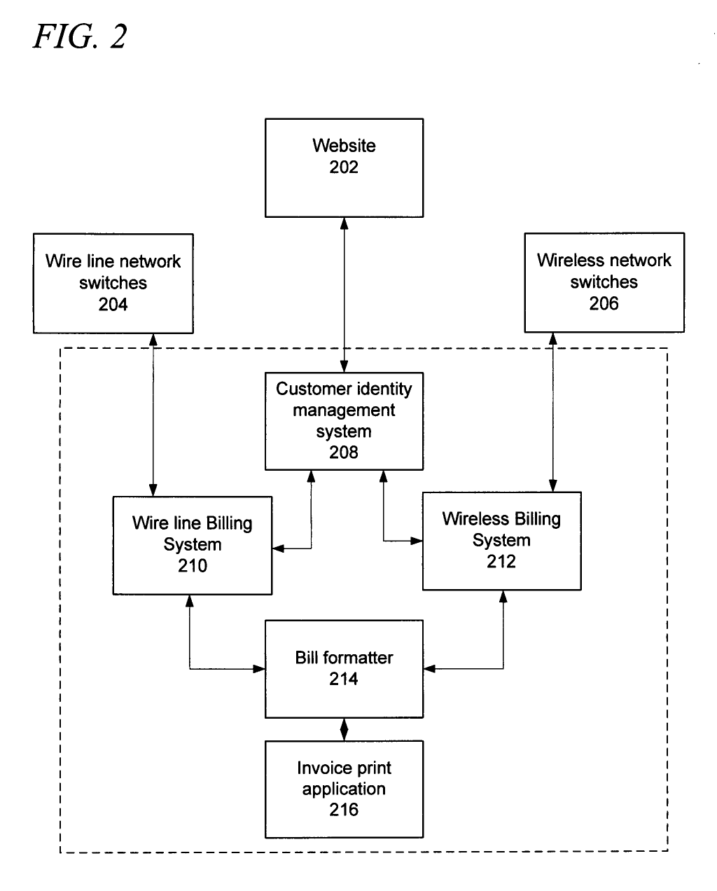

FIG. 2 is a block diagram of a billing system in accordance with an illustrative embodiment of the present invention. FIG. 2 is a block diagram of a billing system 200. The billing system may include various components, including a website with a customer interface 202, wire line network switches 204, wireless network switches 206, a customer identity management system 208, a wire line billing system 210, a wireless billing system 212, a bill formatter 214 and an invoice print application 216.

In one embodiment, the customer identity management system 208, the wire line billing system 210, the wireless billing system 212, the bill formatter 214 and the invoice print application 216 may be part of a server which includes rules-based engine or other applications. The server includes a processor, memory, and the other components of a computing device. The server may store and execute the rules-based engine and the set of instructions to categorize the communications and related expenses. The rules-based engine may allow a user to pre-designate criteria and category designators for separating the expenses. In particular, the rules-base engine may allow the communications service provider to implement a billing service plan that separates the communications and expenses or a billing feature to do the same.

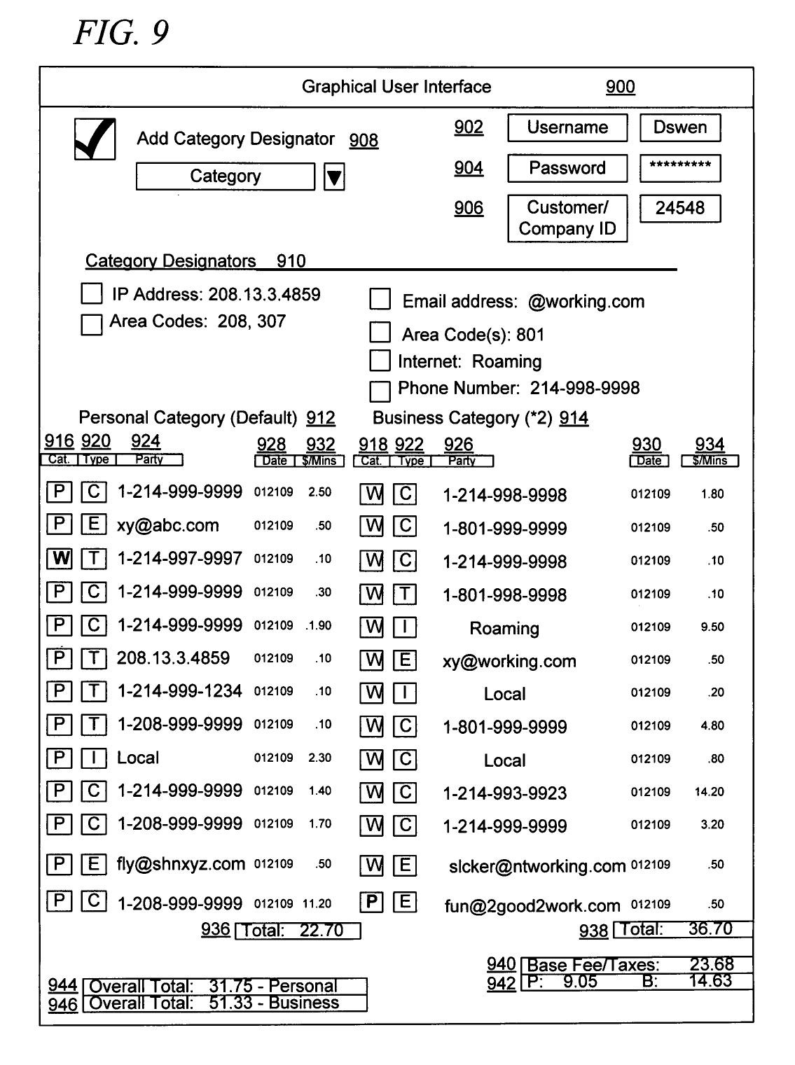

The website 202 may be used to display information to the user and to receive user input. In one embodiment, the user may manage expense allocation for tax and accounting purposes using the website 202. In one embodiment, the website 202 may display a graphical user interface (GUI) as shown and further described in FIG. 9. The website 202 allows the user to specify categories and/or projects to which communications expenses and charges are designated. In one embodiment, the categories may only include personal and business. In other embodiments, the categories may allow for multiple users, separate projects and a nearly limitless amount of categories as specified by the user. For example, within a business category, the user may specify that communications expenses may be billed to clients XYZ or QRS. Alternatively, the user may designate numbers, codes or other identifiers that may be associated with one of a number of projects. By using categories and projects, the expenses are further separated for accounting, expense, and reimbursement purposes. For example, the user may bill a client for communications performed on the client's behalf, but needs an accurate record for sending the data even if the communications are performed from the user's wireless device or home VoIP connection. When selecting a category, the user may also specify the project number using key strokes, voice recognition, or other forms of user input.

The website 202 may also be used to specify criteria for separating the expenses associated with a communication. The billing system 200 further includes wire line network switches 204 and wireless network switches 206. The wire line network switches 204 send and receive data communication signals from a user and/or other network devices necessary for performing the specified communication. In one embodiment, the wire line network switches 204 include all of the necessary components that allow the user to carry on a VOIP conversation. The wire line network switches 204 may communicate with the wire line billing system 210.

In one embodiment, the different website 202 features and functionality may only be enabled if the user has selected a communications service plan that includes the billing separation functionality as a feature. For example, the user may be charged an additional five dollars a month per account in order to be able to separate expenses as herein described. Alternatively, the billing separation features herein described may be provided to every user of a communication service provider in order to encourage users to swap services in order to be able to use wireless devices, VoIP service, POTS, or other communications services for personal and business use or in order to separate calls into different categories.

The wire line billing system 210 may track expenses and costs associated with the user's wire line service. For example, the wire line billing system 210 may record long distance charges associated with the user for long distance phone calls. The wireless network switches 206 similarly communicate wireless signals to an end-user for wireless communication. The wireless billing system 212 is in communication with the wireless network switches 206 to track and record the amount of minutes used for making and receiving calls, text messages, chatting and performing network access features such as accessing the Internet.

The customer identity management system 208 validates that a user or customer is authorized to access the website 202. For example, as previously mentioned the customer identity management system 208 may only provide limited or partial access to the wire line billing system 210 and wireless billing system 212 if the user has subscribed the billing service plan or a communications package that incorporates the service plan. If the user has not purchased the billing service or the communications service provider does not provide it to all customers, the customer identity management system 208 may only allow the user to access certain features or prevent access to the wire line billing system 210 and wireless billing system 212. The customer identity management system 208 may also communicate information from the website 202 to the wire line billing system 210 and wireless billing system 212. In one example, the customer identity management system 208 may set criteria, rules, policies, user preferences and other user input used to categorize communications into the categories to the wire line billing system 210 and the wireless billing system 212. The wire line billing system 210 and the wireless billing system 212 may communicate information recorded regarding telecommunication usage to the bill formatter 214.

The bill formatter 214 may format the data received from the wire line billing system 210 and the wireless billing system 212 to a format and layout that may be passed to the invoice print application 216. In particular, the format may divide the communications expenses by category so that the user may easily ascertain the expenses accrued for each category. The invoice print application 216 may be used to print an invoice or billing record for the user. Alternatively, the invoice print application 216 may format a bill or invoice electronically to be displayed to the user through the website 202, to be sent in an email message or otherwise display using an electronic interface. The billing cycle may dictate how and when the invoice print application 216 formats a bill for transmission to the user. Alternatively, the bill formatter 214 and invoice print application 216 may categorize information received from the wire line billing system 210 and wireless billing system 212 for continuous output to the website 202. As a result, the user may determine at any given time the amount of expenses belonging to each category and usage levels.

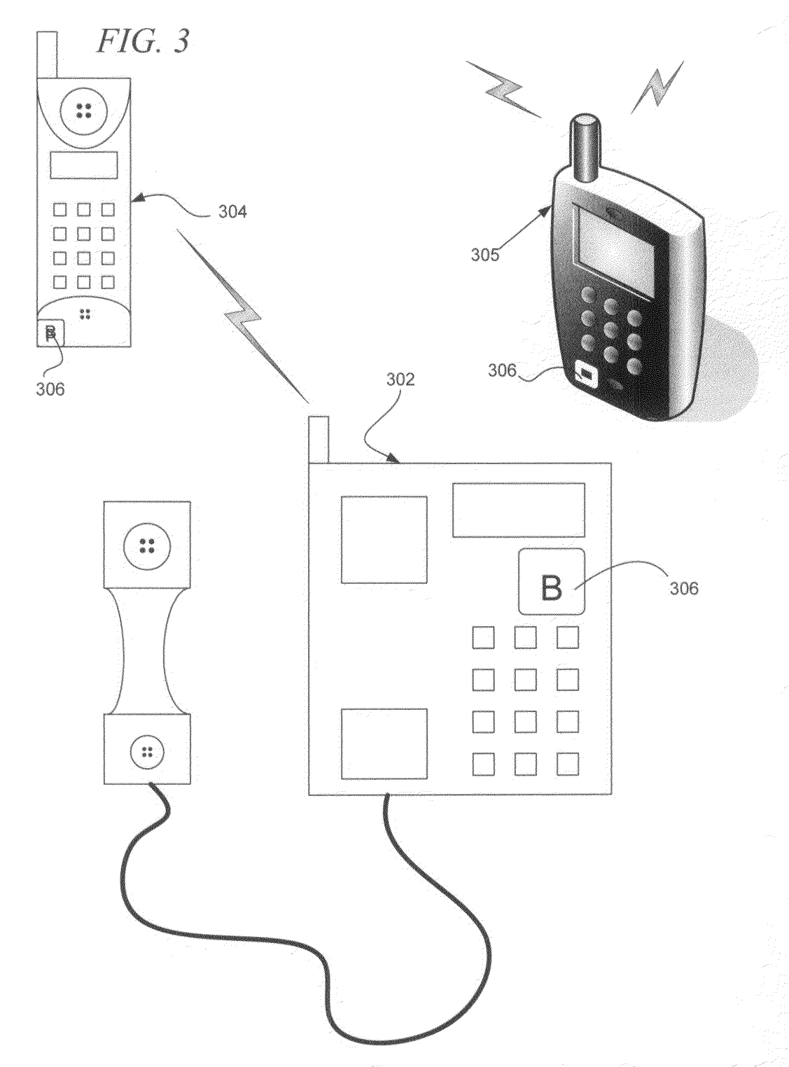

FIG. 3 shows examples of communications devices in accordance with an embodiment of the present invention. FIG. 3 includes a telephone 302, a cordless telephone 304, and a wireless telephone 305. The telephone 302, cordless telephone 304, and wireless telephone 305 may include a feature button 306. The feature button 306 may be an interface that allows the user to send a signal or command to a class 5 switch, mobile switching center, or billing system or other component of the communications system 100 of FIG. 1 for activating a billing feature from the standard telephone 302. Alternatively, the feature button 406 may activate the individual device to perform the requested billing feature.

The feature button 306 may be a dedicated button, programmable or otherwise assignable graphical user interface, touch screen, microphone, scroll wheel, or other input device that generates the command signal that activates the billing feature for the telephone 302, cordless telephone 304, or wireless telephone 305. The telephone 302 and cordless telephone 304 are particular implementations of the standard telephones 122 and 124 of FIG. 1. The feature button 306 may be used to activate any of the methods, services, and expense categorization billing features herein described.

The telephone 302 and cordless telephone 304 may be telephonic devices that operate in conjunction with a publicly switched network or class 5 switch. The telephone 302 may be a POTS phone that functions using an analog connection. In another embodiment, the communication service accessible from the telephone 302 and the cordless telephone 304 may be part of VoIP telephone service or other data or packet network The telephone 302 and cordless telephone 304 are provided dial tone connectivity through a wired connection for a home, business or other location in which the telephone 302 and cordless telephone 304 are located.

The wireless telephone 305 may operate through a wireless network The wireless telephone 305, telephone 302, and cordless telephone 304 may include one or more accelerometers or electro sensitive sensors to receive user feedback in the form of a tactile response. For example, the user may tap the wireless telephone 305 to provide user feedback For example, in order to indicate an incoming call is to be billed to a business category, the user may tap the phone twice. In another embodiment, expense categorization commands may be generated by touching specific portions of the telephonic device. For example, by touching and holding a corner of the wireless telephone 305, the wireless telephone 306 may designate expenses for a business cell phone to a personal category. The user may similarly enter a specific project for billing purposes by touching or entering a number or number sequence on the wireless telephone 305, telephone 302, and cordless telephone 304.

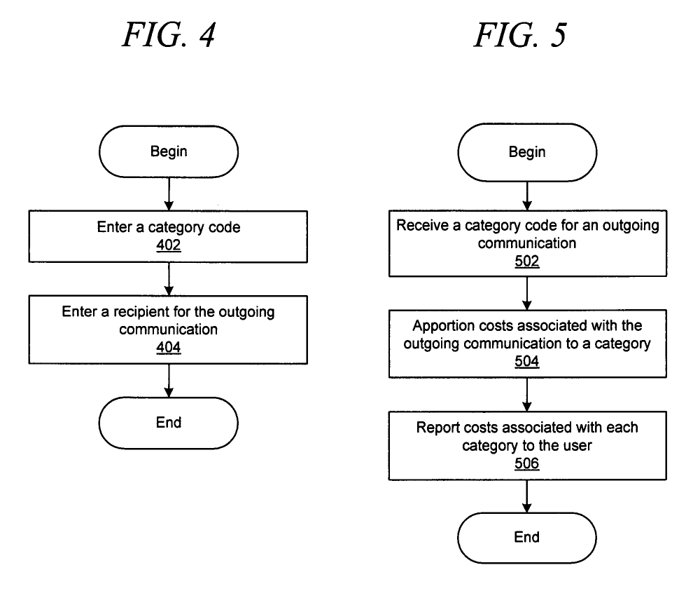

FIG. 4 is a flowchart of a process for selecting a category in accordance with an illustrative embodiment. The process of FIG. 4 may be performed by a user accessing a telephonic device such as a wireless phone or VOIP telephone. The process begins with the user entering a category code (step 402). The category code may be an identifier for associating an outgoing communication with a specified category. In one example, the user may press *2 to assign an outgoing communication to a business category. In that same example, the user may press *1 to assign outgoing communications to a personal category.

In some cases, the user may have established a default category in case a category code is not received. For example, all calls may be categorized to a business category unless user input is recovered indicating otherwise. In a step such as step 402, the outgoing communications may be automatically attributed to the default category. The category code of step 402 may also specify a specific project within the category for further separating and allocating expenses.

Next, the user enters a recipient for the outgoing communication (step 404). The recipient may be specified using a phone number, email address, nickname, user name, or other user identifier. Step 404 may be part of the normal dialing or communication process initiated by the user. By specifying a category in step 402, the outgoing communication is billed or expenses to the specified category for invoicing purposes.

FIG. 5 is a flowchart of a process for apportioning costs in accordance with an illustrative embodiment. The process of FIG. 5 may be implemented by a billing system or database of a wire line or wireless network The process begins by receiving a category code for an outgoing communication (step 502). The category code may be received from a user before or after the user initiates or sends the outgoing communication. The category code may also be received based on a specialized pass code, password, or button of a telephonic device.

Next, the billing system apportions costs associated with the outgoing communication to a category (step 504). For example, if the user is using a VOIP telephone and has specified a business category code, the long distance charges and expenses associated with the long distance call are categorized in the business category. In another embodiment, if a wireless user has selected a personal category and is sending text messages, to the extent that the service plan charges for those text messages, those expenses are separated into the personal category. As a result, communications expenses and records of the communications are electronically separated into the specified category.

The categories may represent a virtual separation in data or a physical separation. In one example, each category is saved in a separate file. In another example, each communication is marked with a designator or identifier indicating the relevant category. The billing system may further apportion costs associated with projects within each category as pre-defined by criteria or specified by the user. Expenses associated with communications as well as a portion of the monthly service fee and taxes may be apportioned to each category for more reasonable and accurate accounting.

The billing system reports costs associated with each category to the user (step 506). The costs and expense associated with each category may be reported in step 506 using any number of ways. In one embodiment, an invoice or bill may be emailed to the user. In another embodiment, the user may receive a hard copy through traditional paper mailing system. Alternatively, the report may be displayed to a user using a database or graphical user interface accessible by the user through a network connection. The report of step 506 preferably shows all communications for the month or designated time period separated by category. Each communication may also show time, duration, costs or expenses, how the categorization was performed, and other helpful or relevant information.

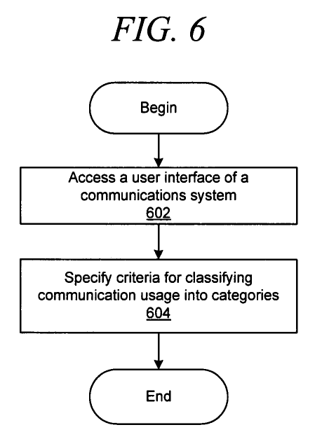

FIG. 6 is a flowchart of a process for specifying criteria in accordance with an illustrative embodiment. The process of FIG. 6 may be implemented by a user with network access to a communications system. For example, the user may use a personal computer and Internet application to access web resources provided by a communication service provider. The process begins by accessing a user interface of a communications system (step 602). The user interface may be accessed by inputting user name and password or otherwise initiating a communication session with a communication service provider.

Next, the user specifies criteria for classifying communication usage in into two or more categories. The criteria may include phone numbers, email addresses, IP addresses, user names or other information to distinguish communications between different users. The user may specify the criteria in step 604 by selecting the criteria from previously made communications or by entering in information using the user interface. In one embodiment, the user may use a graphical user interface to enter phone numbers associated with a personal category. Additionally, the user may also specify phone numbers or area codes associated with a business category. As a result, any communications between the user and the parties specified by the phone number criteria are associated with the specified category for billing purposes. As a result, all business and personal expenses of communications made or received by the user using a service or device are properly characterized for accounting and tax purposes.

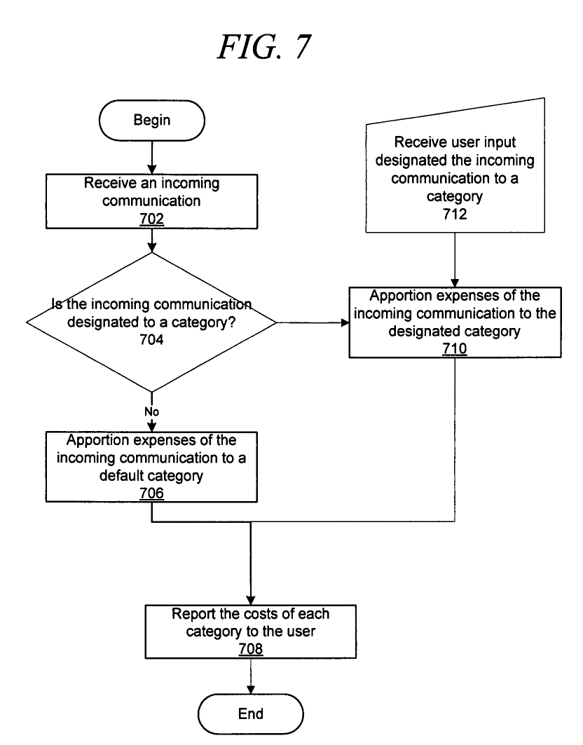

FIG. 7 is a flowchart of a process for apportioning expenses in accordance with an illustrative embodiment. The process of FIG. 7 may be implemented by a billing system in accordance with illustrative embodiments of the present invention. The process begins by receiving an incoming communication (step 702). The incoming communication may be a phone call, text message, chat session or other similar communication.

Next, the billing system determines whether the incoming communication is designated to a category (step 704). The determination of step 704 may be made based on criteria previously submitted by the user. For example, different types of communication may include identifiers that indicate to the billing system that the user has previously selected to characterize the communication to a specified category. If the incoming communication is not designated to a category in step 704, the billing system apportions expenses of the incoming communication to a default category (step 706). In one example, the user may have selected to have all communications billed to a business category, unless otherwise designated.

Next, the billing system reports the cost of each category to the user (step 708). Step 708 may be performed daily, monthly or yearly, as necessary to properly bill the user. In most cases, the user receives a monthly billing statement detailing the costs associated with each category for payment.

If the incoming communication is designated to a category in step 704, the billing system apportions expenses of the incoming communication to the designated category (step 710). Step 710 allows the billing system to separate expenses as specified by the user in order to easily distinguish between different categories of communications performed by the user. As a result, the user may perform accounting and tax tasks without excessive hardship. Next, the billing system reports the cost of each category to the user (step 708).

At any point, as the incoming communication is being received or monitored by the billing system in FIG. 7, the billing system may receive user input designating incoming communication to a category (step 712.) For example, the user may see a name or other caller identification information that helps the user distinguish between a personal or business purpose for the communication. As a result, the user may provide user input to characterize the conversation for properly billing a client or customer at a later time or accounting for use of a service plan or device for business purposes. The user input of step 712 may be received at any time or during or immediately after the conversation to apportion expenses of the incoming communication to the designated category (step 710). For example, once the user begins a voice conversation with a user, the user may select a category for related expenses based on the calling party and purpose of the call.

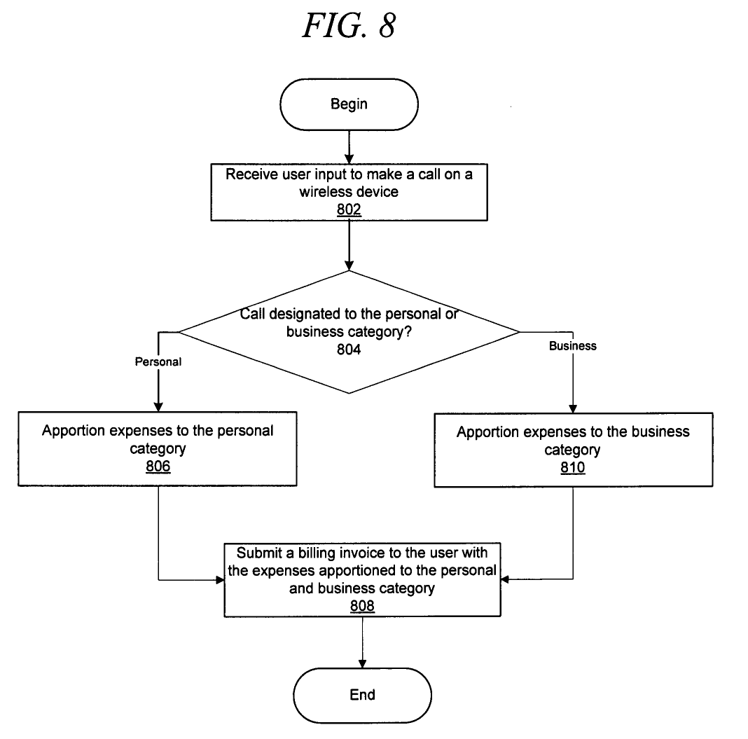

FIG. 8 is a flowchart of a process for apportioning costs for wireless calls in accordance with an illustrative embodiment. The process of FIG. 8 may be implemented by a billing system as previously described. The process of FIG. 8 begins by receiving user input to make a call on a wireless device (step 802). Next, the billing system determines whether the call is designated to a personal or business category (step 804). The determination of step 804 maybe based on user input received from the user at the time the call was placed. For example, the user may have pressed *2 before dialing the receiving party. As a result, the call may be designated to the business category. Alternatively, the user may have previously established a criterion that specifies that all calls placed to an area code, such as 307 are to be automatically separated into the personal category. The user may have also established criteria for separating expenses to different projects or sub-projects within the categories.

If the call is designated to the personal category in step 804, the billing system apportions expenses to the personal category (step 806). Next, the billing system submits a billing invoice to the user with the expenses apportioned to the personal and business category (step 808). The billing invoice may be submitted through email, a web interface or traditional paper means as previously described. If the call is designated to a business category in step 804, the billing system apportions expenses to the business category (step 810).

Next, the billing system submits a billing invoice to the user with the expenses apportioned to the personal and business category (step 808) with the process terminating thereafter. The process of FIG. 8 is a simplified process for specifying whether a call is a personal call or related to business, the process of FIG. 8 may also apply to sending a text message or email, carrying on a chat conversation or accessing the internet via a wireless device to perform either personal or business tasks. As a result, the user may easily determine when the billing invoice is received, which calls were made for business and for personal use. The user may more easily submit a request for reimbursement or reimburse an employer for personal communications that are not covered by the employer. For example, the user may have a wireless device provided by a business with which the user is required to pay for all personal expenses. The process of FIG. 8 allows the user to easily track and record personal and business usage through the billing system in a predefined manner or at the time of communication.

FIG. 9 is a graphical user interface in accordance with an illustrative embodiment. The graphical user interface 900 may be displayed to a user using a client, such as a client 126 of FIG. 1. The graphical user interface 900 may be used to manage expense allocation before, during, and after communications occur by establishing category designators, manually moving communications related expenses, setting user preferences, and providing user input. In one embodiment, the graphical user interface 900 may only be displayed to the user if the user has signed up or subscribed to a communications service plan or billing feature. The added features of the graphical user interface 900 and enhanced billing system provide a method of saving employee and employer time, effort and expense to properly account for different categories and types of expenses.

For example, the graphical user interface 900 may be part of a web browsing application with content populated by a communications service provider, such as website 202 of FIG. 2. Alternatively, the graphical user interface 900 may be printed in the form of a billing or invoice statement sent to the user. The graphical user interface 900 may also be integrated in an email that is sent to the user at the end of a billing cycle. The graphical user interface 200 may include numerous elements including a user name 202, a password 904, a customer/company I.D. 906, an add category designator 908, a category designator 910, a personal category 912, a business category 914, a category 916 and 918, a type 920 and 922, a party 924 and 926, a date and time 928 or 930, cost 932 and 934, total 936 and 938, base fee 940, apportioned total 942, and overall totals 944 and 946.

The user name 902, password 904 and customer/company ID. 906 may be used by a customer identify management system 308 of FIG. 3 to determine whether a user may access the graphical user interface 900. The customer/company identification 906 may be provided in the event that a telephonic device or service is provided by a business for one of their employees. The customer/company identification 906 may be used for reimbursement purposes.

The graphical user interface 900 may be used to separate personal and business expenses as shown in the personal category 912 and the business category 914. The category designators 910 specify pre-selected criteria for classifying communications into the personal category 912 or the business category 914. In other embodiments, the graphical user interface 900 may include any number of categories that may be displayed to the user.

As shown, the category designators specify that the IP address 208.13.3.4859 is assigned to the personal category 912, as well as outgoing calls or text messages to area codes 908 or 307. As a result, any incoming calls, emails, text messages, or other communications from the specified IP address or area codes is separated or categorized into the personal category 912. Similarly, the category designators 910 also include criteria for the business category 914 which include email addresses ending in @working.com, the area code 801, any Internet access that is roaming, and calls to or from the phone number 214-998-9998. The category designators 910 may be used to automatically categorize expenses associated with incoming and outgoing communications based on the included criteria.

The user may use the graphical user interface 900, the add category designator 908, and the category designators 910 to add new categories and criteria at any time, as needed. For example, the user may be a sales manager placed in charge of a geographic area with a corresponding area code beginning with 960. As a result, the user may provide user input designating that all incoming and outgoing calls and related expenses to the area code 960 may be apportioned to the business category 914.

The graphical user interface 900 may show detailed information regarding the category 916 and 918, type 920 and 922, party 924 and 926, date/time 928 and 930, and expense 932 and 934 relating to each incoming and outgoing communication. The category 916 and 918 show which category each communication are categorized to. In one embodiment, the user may manually categorize communications using the categories 916 and 918 in the event that communications are improperly categorized or a change is appropriate. For example, the category designators 910 may not be effective one hundred percent of the time for separating the communications. As a result, the categories 916 and 918 may be used to verify or categorize communications manually or before an invoice or bill is generated. In some examples, the user may be unable to specify criteria within the category designators 910 for separating expenses and a result the user may daily, weekly, or monthly categorize communications using the categories 916 and 918. The user may be able to classify the types of communications by using a toggle button or other icon or interface to move communications between the personal category 912 and the business category 914. For example, at the end of each day, while recent communications are fresh in the user's memory, the user may categorize each communication. The graphical user interface 900 may visually move representations of each communication based on the user input and calculate new totals 936 and 938.

The types 920 and 922 may specify types of communication including cellular phones (C), email (E), text messaging (I), and Internet usage (I), in addition to other services and features offered through a wireless service provider. The types 920 and 922 may also correspond to communication available from a VoIP or POTS telephone.

The party 924 and 926 specifies the party calling or receiving communication from the user and an associated identifier such as a phone number, email address, IP address or other information. The date/time 928 and 930 may specify when the communication occurred. The expenses 932 and 934 may specify an expense amount incurred based on the type of communication. The amount may be a fixed expense, such as a text message, or may vary based on resource usage or minutes spent performing the type of communication, such as phone calls and Internet access.

The graphical user interface 900 may also show all expenses related to the personal category 912 and to the business category 914 in the totals 936 and 938. The totals 936 and 938 show the expenses related to the personal category 912 and the business category 914. The graphical user interface 900 may also show the base fee 940 and apportioned total 942. The base fee 940 includes the fees and taxes associated with the service provided to the user. The apportioned total 942 may be portion of fees attributable to the personal category 912 and the business category 914. In one example, the apportioned total 942 may be calculated for each category based on usage or totals 936 and 938. Alternatively, the user may set a formula or rule for dividing the base fee 940 for each of the categories. For example, the user may specify that 33% of the base fee 940 is to be apportioned to personal, business, and consulting categories.

The graphical user interface 900 may also include the overall totals 944 and 946 for each category that sums the totals 936 and 938 with the apportioned total 942 for each category. As a result, the user may easily determine how often the device is being used for personal and business use. The billing system and graphical user interface 900 may encourage more business and individuals to use a single device for greatly enhancing communication. Additionally, many users may not need to carry separate communications devices for separate purposes. The graphical user interface 900 may be printed for submitting a reimbursement form to an employer or confirmation of usage statement that may be required for tax or accounting purposes. Before, during, or after communications a user may separate communications and expenses for tracking, record keeping, billing, reimbursement, and accounting purposes.

The previous detailed description is of a small number of embodiments for implementing the invention and is not intended to be limiting in scope. The following claims set forth a number of the embodiments of the invention disclosed with greater particularity.

What is claimed:

1. A method for implementing a billing service plan for separating communications expenses said method comprising:
separating expenses related to a communication for an individual user into two or more categories based on user input before, during, or after the communication occurs;
apportioning the expenses of the communication to the two or more categories based on the user input; and
generating an invoice for one or more parties specifying the expenses apportioned to the two or more categories.

2. The method according to claim 1, wherein the one or more parties include a personal user and a business.

3. The method according to claim 1, wherein the communication is for any of a voice over Internet Protocol telephone, a wireless telephone, a digital telephone, and an analog telephone.

4. The method according to claim 1, wherein the separating is performed based on phone numbers classified into the two or more categories.

5. The method according to claim 1, wherein the apportioning further comprises:
dividing a base fee of telecommunication service between the two or more categories based on the telecommunication usage for the expenses in the invoice.

6. The method according to claim 1, wherein separating occurs at a time of the communication based on a button selection or voice command.

7. The method according to claim 1, further comprising:
managing the separation of the expenses using an interface available to the user based on a subscription to the billing service plan.

8. The method according to claim 1, wherein the two or more categories include business and personal.

9. The method according to claim 1, wherein separating further comprises:
designating in advance criteria for separating expenses associated with the communication to the two or more categories.

10. The method according to claim 9, wherein the criteria includes any of a phone number, email address, caller identification information, and Internet Protocol address.

11. The method according to claim 1, wherein separating further comprises:
assigning a call, chat, text, email, or Internet session to the two or more categories.

12. The method according to claim 1, wherein apportioning further comprises:
apportioning expenses between the one or more parties based on the two or more categories.

13. The method according to claim 1, wherein generating further comprises:
sending the invoice to the one or more parties.

14. A billing system for separating communications expenses, said system comprising:
a server configured to separate a communication into two or more categories based on a user input, apportion expenses related to the communication to one of the two or more categories, and separate the expenses based on the two or more categories in an invoice to a user, and
a communications network in communication with the server, the communications network configured to send and receive the communication for the user.

15. The billing system according to claim 11, further comprising:
a client in communication with the server configured to display a graphical for receiving the user input.

16. The billing system according to claim 11, wherein totals for the expenses of the two or more categories are sent to the user for accounting purposes.

17. A billing system for managing communications expenses comprising:
a rules-based engine for executing a set of instructions to categorize the communications expenses; and
the set of instructions configured to categorize a communication into two or more categories based on user input, apportion expenses of the communication based on the two or more categories, and separate the expenses based on the two or more categories in an invoice to a user.

18. The billing system according to claim 17, wherein the user input is received prior to an occurrence of the communication for automatically separating communications into the two or more categories based on user input received through a graphical user interface generated by the set of instructions.

19. The billing system according to claim 11, wherein the user input is received during or subsequent to the communication wherein separation of the communication is performed in response to receiving the user input.

20. The billing system according to claim 11, wherein the set of instructions generates one or more invoices to deliver to one or more users for accounting purposes, wherein the set of instructions apportions a base cost of a communications service to each of the one or more categories based on usage.
